(19) United States
(12) Patent Application Publication
(10) Pub. No.: US 2009/0204622 A1
(43) Pub. Date: Aug. 13, 2009

(54) VISUAL AND NON-VISUAL CUES FOR CONVEYING STATE OF INFORMATION CARDS, ELECTRONIC WALLETS, AND KEYRINGS

(75) Inventors: Daniel S. Sanders, Orem, UT (US); Duane F. Buss, West Mountain, UT (US); Thomas E. Doman, Pleasant Grove, UT (US); Andrew A. Hodgkinson, Pleasant Grove, UT (US); James G. Sermersheim, Woodland Hills, UT (US); John M. Calcote, Elk Ridge, UT (US)

Correspondence Address: MARGER JOHNSON & MCCOLLOM, P.C. - NOVELL, 210 SW MORRISON STREET, SUITE 400, PORTLAND, OR, 97204, US

(73) Assignee: NOVELL, INC., Provo, UT (US)

(21) Appl. No.: 12/029,373

(22) Filed: Feb. 11, 2008

(51) Int. Cl. G06F 3/048; G06F 17/30

(52) U.S. Cl. 707/100; 715/781; 707/E17.044

(57) ABSTRACT

A user desires to select information about himself. The system uses policies applicable to the display of the user's information and metadata about the user and the information to determine modified presentations of the user's information. The modified information can include visual and non-visual cues (such as aural, olfactory, or tactile). The system then displays the modified information, presenting the user with the visual and non-visual cues about the information.

### RELATED APPLICATION DATA

This patent application is related to co-pending U.S. patent application Ser. No. 11/843,572, filed Aug. 22, 2007, co-pending U.S. patent application Ser. No. 11/843,638, filed Aug. 22, 2007, and to co-pending U.S. patent application Ser. No. 11/843,640, filed Aug. 22, 2007, all of which are hereby incorporated by reference for all purposes and all of which claim the benefit of U.S. Provisional Patent Application Ser. No. 60/895,325, filed Mar. 16, 2007, of U.S. Provisional Patent Application Ser. No. 60/895,312, filed Mar. 16, 2007, and of U.S. Provisional Patent Application Ser. No. 60/895,316, filed Mar. 16, 2007, all of which are all hereby incorporated by reference for all purposes.

### FIELD OF THE INVENTION

This invention pertains to on-line transactions, and more particularly to presenting cues regarding the state of information used in performing on-line transactions.

### BACKGROUND OF THE INVENTION

When a user interacts with sites on the Internet (hereafter referred to as “service providers” or “relying parties”), the service provider often expects to know something about the user that is requesting the services of the provider. The typical approach for a service provider is to require the user to log into or authenticate to the service provider's computer system. But this approach, while satisfactory for the service provider, is less than ideal to the user. First, the user must remember a username and password for each service provider who expects such information. Given that different computer systems impose different requirements, and the possibility that another user might have chosen the same username, the user might be unable to use the same username/password combination on each such computer system. (There is also the related problem that if the user uses the same username/password combination on multiple computer systems, someone who hacks one such computer system would be able to access other such computer systems.) Second, the user has no control over how the service provider uses the information it stores. If the service provider uses the stored information in a way the user does not want, the user has relatively little ability to prevent such abuse, or recourse after the fact.

To address this problem, new systems have been developed that allow the user a measure of control over the information stored about the user. Windows CardSpace™ (sometimes called CardSpace) is a Microsoft implementation of an identity meta-system that offers a solution to this problem. (Microsoft. Windows, and CardSpace are either registered trademarks or trademarks of Microsoft Corporation in the United States and/or other countries.) A user can store identity information with an identity provider the user trusts. When a service provider wants some information about the user, the user can control the release of information stored with the identity provider to the service provider. The user can then use the offered services that required the identity information.

But the information used by the user is not necessarily constant over time. For example, the user might want to provide the relying party information about a credit card of the user. Credit cards do not last forever: they have an expiration date. If the user does not check the actual credit card before information is transmitted to the relying party and the credit card had expired, the user might be surprised when the relying party refuses to complete the transaction.

A need remains for a way to addresses these and other problems associated with the prior art.

### SUMMARY OF THE INVENTION

In an embodiment of the invention, before a client selects information to be used in a transaction, the system determines the state of the information. Based on the state of the information, the system can present the client with cues regarding the state of the information. These cues can be visual or non-visual. The client can then select information to be used in the transaction based on the cues.

The foregoing and other features, objects, and advantages of the invention will become more readily apparent from the following detailed description, which proceeds with reference to the accompanying drawings.

### BRIEF DESCRIPTION OF THE DRAWINGS

FIG. 1 shows a sequence of communications in a computer system between a client, a relying party, and an identity provider.

FIG. 2 shows a system to provide a client with visual and/or non-visual cues regarding the state of information to be used in a transaction with the relying party, according to an embodiment of the invention.

FIG. 3 shows the card selector of FIG. 2 presenting the client with visual and/or non-visual cues.

FIG. 4 shows a mechanism for defining the policies of FIG. 2.

FIG. 5 shows a modifier used to modify the presentation of information in the system of FIG. 2.

FIG. 6 shows a system to provide a client with visual and/or non-visual cues regarding the state of information to be used in a transaction with the relying party, according to a second embodiment of the invention.

FIG. 7 shows the client and identity provider in the system of FIG. 6 communicating via multiple channels.

FIG. 8 shows a flowchart of a procedure to present the user with visual and/or non-visual cues regarding the state of information in system of FIG. 2 and 7.

FIG. 9 shows details regarding the presentation of visual and/or non-visual cues regarding the state of information in the flowchart of FIG. 8.

FIG. 10 shows details regarding the use of metadata in the presentation of visual and/or non-visual cues regarding the state of information in the flowchart of FIG. 8.

### DETAILED DESCRIPTION OF THE PREFERRED EMBODIMENT

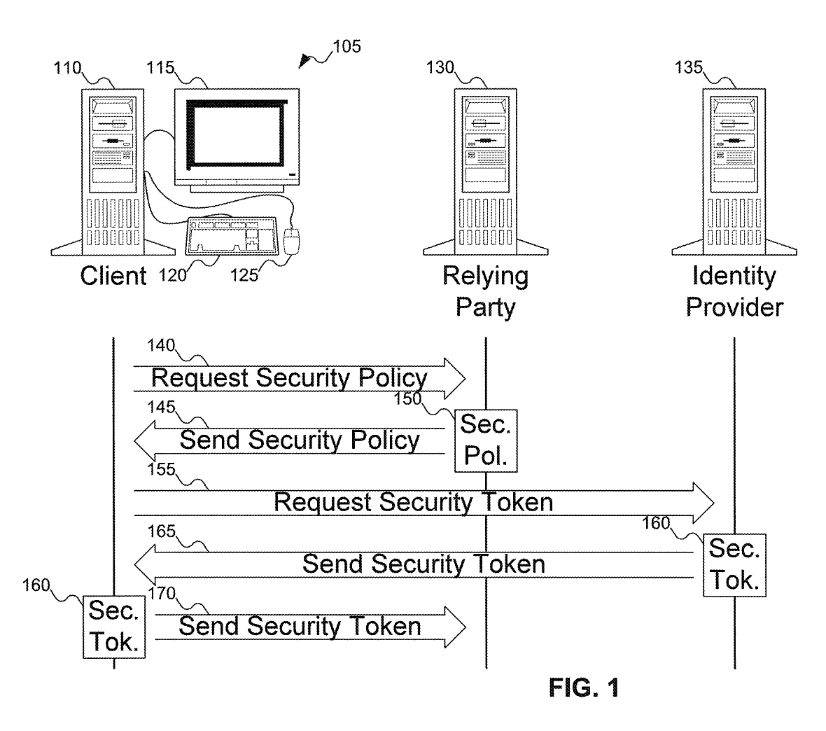

Before explaining the invention, it is important to understand the context of the invention. FIG. 1 shows a sequence of communications between a client, a relying party, and an identity provider. For simplicity, each party (the client, the relying party, and the identity provider) may be referred to by their machines. Actions attributed to each party are taken by that party's machine, except where the context indicates the actions are taken by the actual party.

In FIG. 1, computer system 105, the client, is shown as including computer 110, monitor 115, keyboard 120, and mouse 125. A person skilled in the art will recognize that other components can be included with computer system 105: for example, other input/output devices, such as a printer. In addition, FIG. 1 does not show some of the conventional internal components of computer system 105; for example, a central processing unit, memory, storage, etc. Although not shown in FIG. 1, a person skilled in the art will recognize that computer system 105 can interact with other computer systems, such as relying party 130 and identity provider 135, either directly or over a network (not shown) of any type. Finally, although FIG. 1 shows computer system 105 as a conventional desktop computer, a person skilled in the art will recognize that computer system 105 can be any type of machine or computing device capable of providing the services attributed herein to computer system 105, including, for example, a laptop computer, a personal digital assistant (PDA), or a cellular telephone.

Relying party 130 is a machine managed by a party that relies in some way on the identity of the user of computer system 105. The operator of relying party 130 can be any type of relying party. For example, the operator of relying party 130 can be a merchant running a business on a website. Or, the operator of relying party 130 can be an entity that offers assistance on some matter to registered parties. Relying party 130 is so named because it relies on establishing some identifying information about the user.

Identity provider 135, on the other hand, is managed by a party responsible for providing identity information (or other such information) about the user for consumption by the relying party. Depending on the type of information identity provider 135 stores for a user, a single user might store identifying information with a number of different identity providers 135, any of which might be able to satisfy the request of the relying party. For example, identity provider 135 might be a governmental agency, responsible for storing information generated by the government, such as a driver's license number or a social security number. Or, identity provider 135 might be a third party that is in the business of managing identity information on behalf of users.

The conventional methodology of releasing identity information can be found in a number of sources. One such source is Microsoft Corporation, which has published a document entitled Introducing Windows CardSpace, which can be found on the World Wide Web at http//msdn2.microsoft.com/en-us/library/aa480189.aspx and is hereby incorporated by reference. To summarize the operation of Windows CardSpace, when a user wants to access some data from relying party 130, computer system 105 requests the security policy of relying party 130, as shown in communication 140, which is returned in communication 145 as security policy 150. Security policy 150 is a summary of the information relying party 130 needs, how the information should be formatted, and so on.

Once computer system 105 has security policy 150, computer system 105 can identify which information cards will satisfy security policy 150. Different security policies might result in different information cards being usable. For example, if relying party 130 simply needs a user's e-mail address, the information cards that will satisfy this security policy will be different from the information cards that satisfy a security policy requesting the user's full name, mailing address, and social security number. The user can then select an information card that satisfies security policy 150.

Once the user has selected an acceptable information card, computer system 105 uses the selected information card to transmit a request for a security token from identity provider 135, as shown in communication 155. This request can identify the data to be included in the security token, the credential that identifies the user, and other data the identity provider needs to generate the security token. Identity provider 135 returns security token 160, as shown in communication 165. Security token 160 includes a number of claims, or pieces of information, that include the data the user wants to release to the relying party. Security token 160 is usually encrypted in some manner, and perhaps signed and/or time-stamped by identity provider 135, so that relying party 130 can be certain that the security token originated with identity provider 135 (as opposed to being spoofed by someone intent on defrauding relying party 130). Computer system 105 then forwards security token 160 to relying party 130, as shown in communication 170.

In addition, the selected information card can be a self-issued information card: that is, an information card issued not by an identity provider, but by computer system 105 itself. In that case, identity provider 135 effectively becomes part of computer system 105.

In this model, a person skilled in the art will recognize that because all information flows through computer system 105, the user has a measure of control over the release of the user's identity information. Relying party 130 only receives the information the user wants relying party 130 to have, and does not store that information on behalf of the user (although it would be possible for relying party 130 to store the information in security token 160: there is no effective way to prevent such an act).

But, as noted above, the user might select an information card that is out of date, such as an expired credit card. The client, with no way to know this fact (without looking at the physical credit card), would not know of the problem until the relying party refused to consummate the transaction because of the out-of-date information.

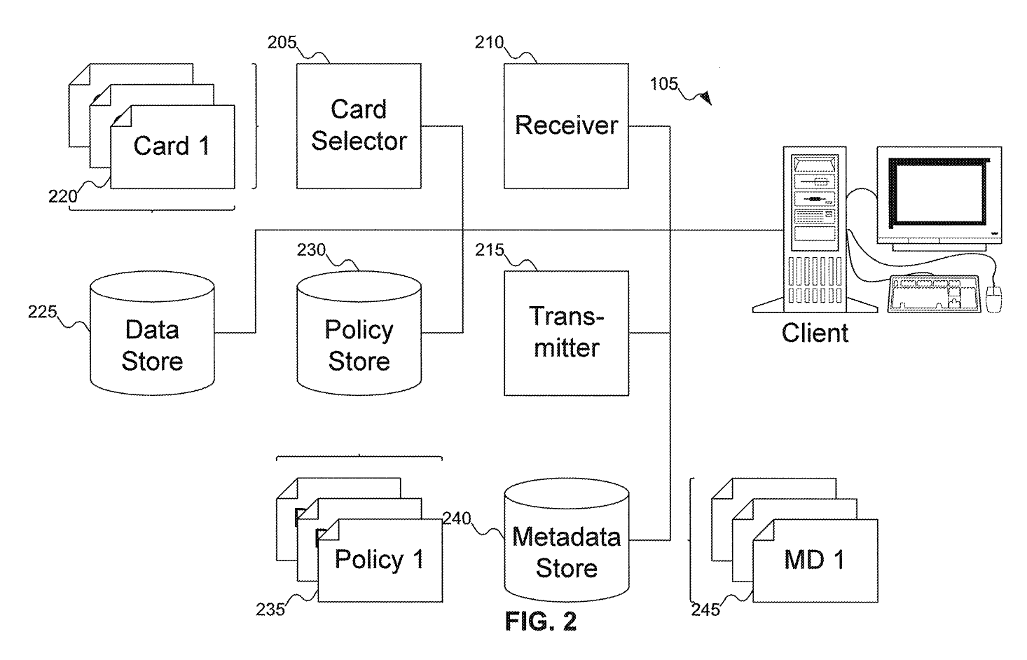

Now that the problem—providing cues to the user client regarding the state of his or her data—is understood, a solution to the problem can be explained. FIG. 2 shows a system to perform a transaction that provides the client with such cues on computer system 105, according to embodiments of the invention. In FIG. 2, computer system 105 includes card selector 205, receiver 210, and transmitter 215. Card selector 205 is responsible for enabling a user to select information card 220 that satisfies the security policy. Receiver 210 is responsible for receiving data transmitted to computer system 105, and transmitter 215 is responsible for transmitting information from computer system 105. These components are the same as those found in computer system 105 as shown in FIG. 1.

A person skilled in the art will recognize that card selector 205 is simply one way to store data with which cues can be used. For example, data store 225, which can be any type of data store, can be used to store data to which cues can be applied. If a different type of data store is used other than card selector 205, then information card 220 can be replaced with an appropriate type data. For example, data store 220 can be, among other possibilities, an electronic wallet, or a key ring, with information card 220 replaced with the appropriate data types for the information stored in data store 220. While the remainder of this document centers on the use of cues with respect to information cards in card selector 220, a person skilled in the art will recognize how embodiments of the invention can be modified to apply to other types of date stores.

Computer system 105 also includes policy store 230. Policy store 230 stores policies, such as policy 235, which describe how to apply the cues to the information cards in card selector 205.

Finally, computer system 105 includes metadata store 240. Metadata store 240 stores metadata, such as metadata 245, about the information cards. The metadata in metadata store 240 is used by the policies in policy store 230 to control the application of cues to the information cards in card selector 205. Examples of metadata that can be stored in metadata store 240 can include an image associated with the information card, a name for the information card, the frequency with which the information card has been used, the relying parties who have been provided data based on the information card, the expiration date of the information card, whether there is an indication that the information card has been stolen, a financial state of the information card (for example, is the information card approaching its credit limit, or does the information card represent a bank account that is low on finds), and so on.

Although the various data stores of FIG. 2 are shown as discrete storage elements, a person skilled in the art will recognize that they can be combined. For example, a single data store can be responsible for storing all of the data: information card 220, policy 235, and metadata 245. Further, the various data elements can be stored in various formats, such as a database. Finally, while FIG. 2 shows the storage elements as being integral parts of computer system 105, a person skilled in the art will recognize that the storage elements can be stored anywhere that the data can be accessed from computer system 105: for example, on network attached storage or a USB flash drive, to provide two examples.

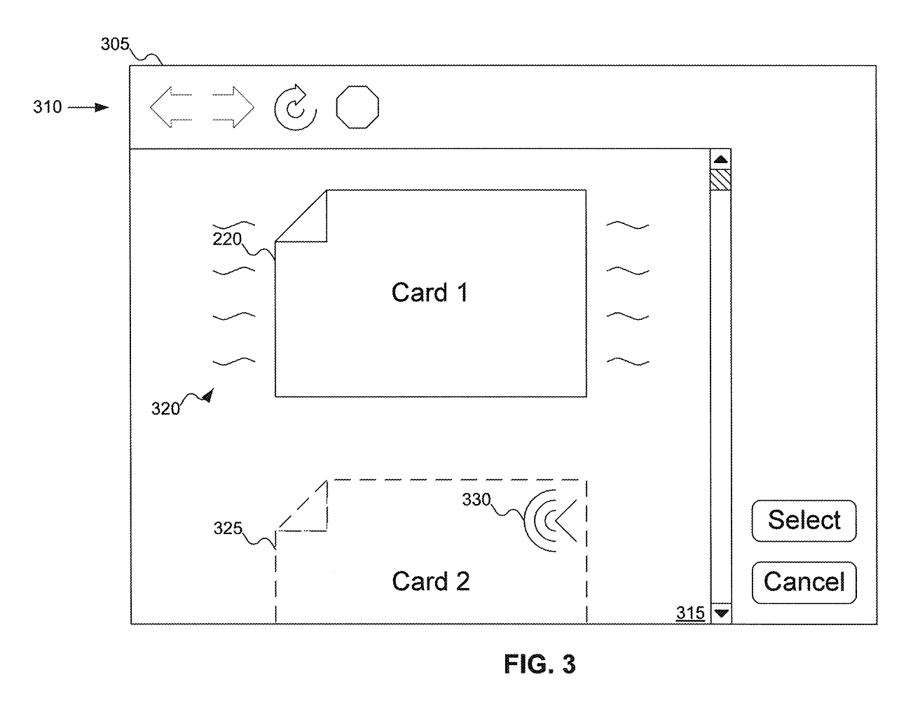

FIG. 3 shows the card selector of FIG. 2 presenting the client with visual and/or non-visual cues. In FIG. 3, screen 305 shows what card selector 205 might display to the user. Among other options, screen 305 can include navigation buttons 310, to permit the user to navigate around within card selector 205. Screen 305 can also include a main area 315, where cards can be displayed to the user.

In main area 315, one card (and a portion of a second card) are shown. Information card 220 is shown with “stink lines” 320, which are a visual representation that information card 220 is no longer “fresh”. “Stink lines” 320 can be static, or can “shimmer” on screen, as desired. “Stink lines” 320 can be used to represent that there is a problem with information card 220. For example, if information card 220 represents a credit card, stink lines 320 might indicate that the credit card is going to expire soon, or that it is suspected that the credit card has been used by someone other than the person to whom the card was issued.

Aside from “stink lines” 320, other visual cues that can be used to provide the user with information about the cards include a name of the card, the issuer of the card, brightening or fading the card, shrinking or enlarging the card, fraying, burning, curling, flames, or otherwise changing the appearance of the edges of the card, flashing the card, changing the color of the card, displaying the card as wobbly, cracked, cut, or melting, making the card transparent, applying overlays or shading, converting the card to a monochrome, black-and-white, or sepia presentation, and so on. A person skilled in the art will recognize other possible visual cues: for example, changing the font size or font color of text on the information card.

As further examples of how visual cues can be provided to the user, cards that are considered “good” can be marked with an OK symbol, a check mark, or a green traffic light. Cards considered “bad” can be marked with wavy lines, such as “stink lines” 320, storm clouds, a garbage can or garbage symbols, or a red traffic light. If the reputation of a card is rated along a spectrum (rather than just being “good” or “bad”), stars, bars, percentages, or red\green\yellow light tri-level traffic lights can be used.

While the above description of visual cues is primarily focused in icons and images that tend to be static in nature (although “stink lines” 320 are described above as potentially “shimmering”), a person skilled in the art will recognize that visual cues can include cues that are not static in nature. For example, as described above, the information card can “phase” or transition between cues. Visual cues can also include animations, movies, and other non-static images. Visual cues can also non-visual aspects: for example, animations and movies can include aural aspects, such as sound, music, and speech.

Aside from visual cues, card selector 205 can also preset to the user non-visual cues regarding the state of information cards. For example, information card 325 is “shown” with aural sound 330. Aural sound 330 is an aural cue to the user regarding the state of information card 325. For example, aural information might be a siren sound, alerting the user to a problem with information card 325. Other non-visual cues can include beeps, spoken warning or information messages, and so on. A person skilled in the art will recognize other possible aural cues.

Cues can take other forms as well, such as olfactory or tactile. For example, given the appropriate technology, card selector 205 might use a smell generator to release a “rotten egg”-type smell for an information card that is on the verge of expiring (or expired). Or, perhaps using force feedback technology, card selector 205 suggest to the user that a particular card should not be used (by making it difficult to move the cursor toward the particular information card, or making the particular information card “run away” from the cursor). Non-visual cues, such as music, sounds, spoken words, and smells can also be organized into themes, as discussed above with reference to visual cues. A person skilled in the art will recognize other ways in which card selector 205 can present non-visual cues to the user regarding the state of the information card.

Cues can be organized into “themes”. A “theme” is a set of cues that have a common element. Examples of themes that can be used for visual cues include road signs, the red/yellow/green tri-level traffic light, emoticons, animal symbols, pop culture symbols, celebrity symbols, and sports symbols, among other possibilities. Themed visual cues can be used to provide a presentation of the cues that is consistent overall. A person skilled in the art will recognize how non-visual cues can also be organized into themes, and that themes can include cues of various different types. For example, an “emergency services” theme can include icons of emergency service vehicles, such as police cars, fire trucks, and ambulances, animations such as flashing red lights, and sirens (i.e., noises) to correspond to the emergency service vehicles and animations.

As discussed above with reference to FIG. 2, card selector 205 uses policies, such as policy 235, and metadata, such as metadata 245, to determine the appropriate cues to apply to a particular information card. Policy 235 defines how a particular information card is to be presented, based on its current state, which can be reflected by metadata 245. Thus, for example, policy 235 can specify that when a card is within one month of its expiration date (which would be stored as metadata 245), a particular cue (visual, aural, olfactory, tactile, or any desired cue) can be applied to the information card to modify its presentation to the user.

Policy 235 can also indicate how it interacts with other policies. For example, there might be one policy applied when it appears that an information card has been stolen, and another policy applied when an information card is nearing its expiration date. How these two policies interact can be defined by the policies themselves. It might be that both policies are applied or only one or the other is applied. For example, the policy applied when an information card has been stolen might trump all other policies (as the theft of the information card might make it unwise to use the information card for any reason at all). Or both policies might be applied, if they do not conflict. As an example of how this might work, the policy applied when an information card is stolen might include a siren (an aural cue), whereas the policy applied when an information card is approaching its expiration date might include “stink lines) (a visual cue).

Although the above example uses cues of different types, which permits multiple different types of cues (aural vs. visual) to be applied simultaneously, this does not mean that cues of the same type cannot be used simultaneously. For example, a card might be colored red (to indicate it was potentially stolen) and have stink lines (to indicate it is approaching its expiration date). Or the information card might “phase” between different cues (that is, alternate between the two cues, and gradually changing between the them), so that the user can be presented with both cues in a situation where one cue, if applied all the time, would prevent the presentation of another cue. A person skilled in the art will recognize other ways in which policies can specify how they interact.

While the human eye can detect things in its peripheral vision, a user is typically capable of distinguishing visual cues applied to different information cards. Non-visual cues, on the other hand, are not so easily distinguished. If there are multiple non-visual cues relating to different information cards presented to the user at the same time, the user may be unable to determine which non-visual cue applies to which information card (and, of course, which information cards are not the subject to a non-visual cue). In one alternative embodiment of the invention, card selector 205 can vary the impact of cues (which can include visual cues as well as non-visual cues) based on what information is currently the focus of the user's attention. For example, card selector 205 might not present any cues regarding information cards not currently on screen, and might vary the strength of the cue depending on how much of the information card is on screen, or how near the mouse pointer is to the information card (the mouse pointer being only one possible way of determining the user's current focus). Thus, by card selector 205 presenting cues with varying strengths, the user is made aware (based on the strength of the cue) of which cues apply to which information cards.

In other embodiments of the invention, card selector 205 can present cues, regardless of the focus of the user or whether the information card is on screen. For example, card selector 205 might provide the user with the appropriate cue for an information card that has been stolen regardless of the visibility of the stolen information card or the level of the user's focus on the information card. In this manner, the user can be made aware of the potential problem (that an information card has been stolen), whether or not the user was interested in the stolen information card.

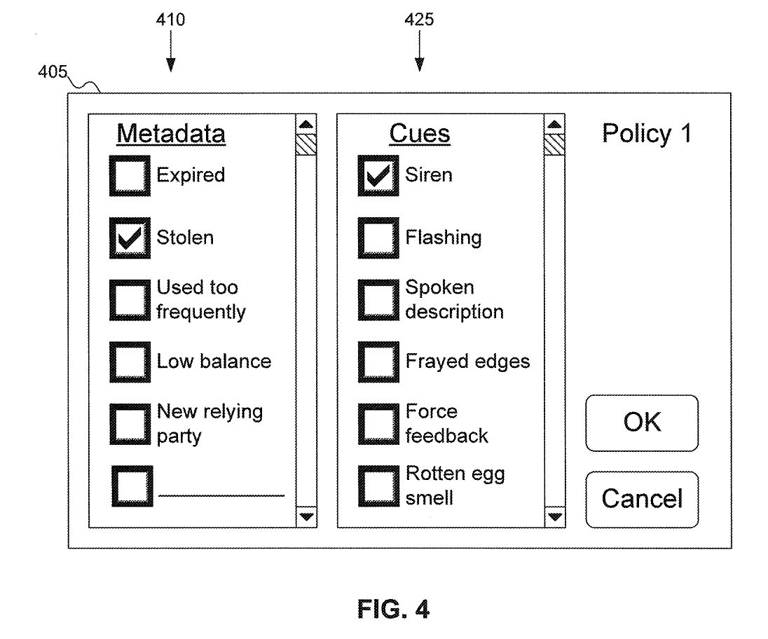

Policy 235 can be stored in policy store 230 in a number of different ways. Policy store 230 might include a number of default policies, provided when the user installs an embodiment of the invention. Or the user can define policy 235 manually (which can include both creating a new policy from scratch and modifying an existing policy). A person skilled in the art will recognize how policies can be defined. For example, the user can use a graphical interface to define policies, such as that shown in FIG. 4. In FIG. 4, the user is defining a policy named “Policy 1”. The user can choose a metadata that acts as a trigger for the policy, and a cue to be used when the specific metadata trigger is found to be met. Then, when the policy is saved in policy store 230 and a particular information card is loaded into card selector 205, the policy is checked against the metadata for the information card. If the policy indicates that a cue should be applied, then the card selector can present the information card using the specified cue.

For the sake of simplicity, FIG. 4 does not show how a user might specify how multiple policies interoperate, but a person skilled in the art will understand how this can occur. For example, the user can specify whether or not policies of different types can both be applied or not. For policies of the same type, the user can specify whether the highest priority policy (which can be indicated by an ordering of the policies) always trumps a lower priority policy of the same type, or if the card selector should phase between the different applicable policies. A person skilled in the art will recognize other ways in which policy management can be implemented.

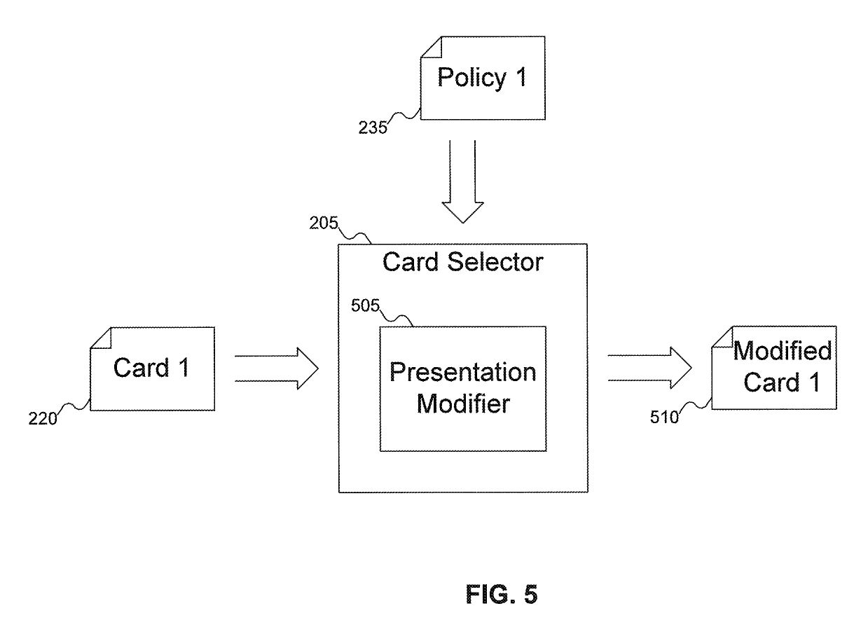

FIG. 5 shows a modifier used to modify the presentation of information in the system of FIG. 2. In FIG. 5, card selector 205 includes modifier 505. Modifier 505 is responsible for modifying the presentation of the information card, to reflect the applicable policy. In FIG. 5, modifier 505 shown applying a single policy to a single information card, but a person skilled in the art will recognize that modifier 505 can operate on all information cards, and can apply multiple policies to any individual information card.

In FIG. 5, it is assumed that policy 235 is applicable to information card 220. This can be determined in any number of ways. For example, as each information card available to the user is identified, card selector 205 can determine whether any individual policy is applicable to the information cards. But a person skilled in the art will recognize that other implementations are possible. For example, modifier 505 can be responsible for identifying which policies are applicable to individual information cards, as well as the appropriate modification of the presentation of the information cards (in this situation, modifier 505 might directly access policy store 230, and so would not necessarily receive an individual policy to apply to an information card).

Modifier 505 takes policy 235 and determines how information card 220 should be modified. This modification presents to the user the cues applicable to information card 220. For example, modifier 505 can modify the visual appearance of information card 220, if policy 235 specifies a visual cue. Similarly, if policy 235 specifies a non-visual cue, modifier 505 can modify the non-visual presentation of information card 505. The result produced by modifier 505 is modified card 510, which can then be presented to the user by card selector 205.

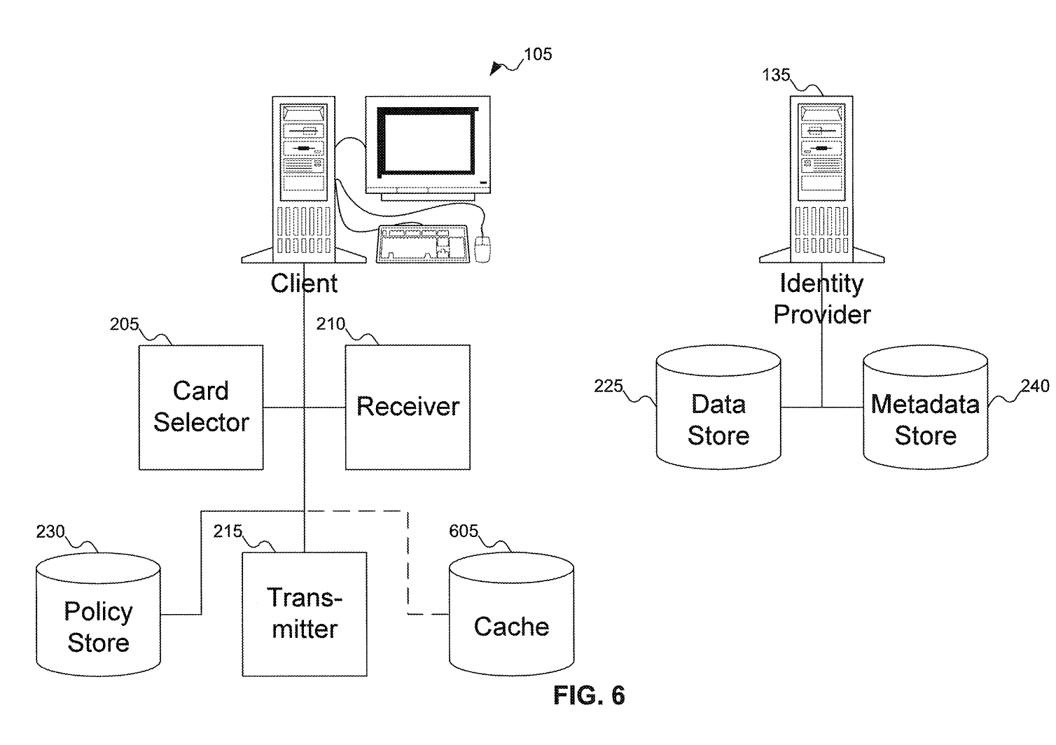

In the above described embodiments of the invention, it is assumed that all the pertinent information (such as the information cards and the metadata which trigger the application of a policy) is stored on computer system 105. But this is not always the case. For example, relying parties are not always willing to trust that information provided by the user is accurate, and may only accept information received from a third party that is independently trustworthy, such as identity provider 135. In such situations, where identity provider 135 stores the information cards, the system configuration is different, as shown in FIG. 6. Computer system 105 still includes card selector 205, receiver 210, transmitter 215, and policy store 230. But identity provider 135 stores data store 225 and metadata store 240. As with the system of FIG. 2, data store 225 stores the data to be used in the transaction, such as information card 220, and metadata store 240 stores metadata about data store 225. Identity provider 135 stores metadata store 240 because with managed information cards, if the user were to use the information card from multiple client computer systems, no single computer system might have complete information about the information card, but identity provider 135 would. Further, if the information card were stolen and used by an unauthorized third party, only identity provider 135 would store that information: no client computer system used by the user would know this fact.

In the system of FIG. 6, operation is basically the same as in the system of FIG. 2. But instead of locally accessing metadata store 240, computer system 105 requests the metadata from metadata store 240 on identity provider 135. And because card selector 205 presents the visual and non-visual cues to the user before computer system 105 requests a security token from identity provider 135, the metadata is needed from identity provider 135 before computer system 105 requests a security token from identity provider 135. More importantly, computer system 105 cannot request the metadata at the same time it requests the security token from identity provider 135, as by that time the user has already selected an information card, limiting the value added by embodiments of the invention. Computer system 105 can request the metadata from identity provider 135 each time card selector 205 is invoked. But because a single user might have information cards managed by multiple identity providers, to make such a request and wait for the response from each identity provider, aside from potentially slowing down the operation of card selector 205, is tedious.

FIG. 6 shows policy store 230 on computer system 105 because policies, such as policy 235, might be applicable to multiple information cards, which could be managed by different identity providers. By storing policy store 230 on computer system 105, the policies can be applied by computer 105 regardless of where the information cards are stored. But a person skilled in the art will recognize that policy store 230 can also be “outsourced” (that is, stored somewhere other than on computer system 105, although not necessarily on identity provider 135), to enable the use of the policies on multiple computer systems. In such a situation, computer system 105 would request copies of the policies, to be able to apply them to information cards as needed.

One way to address the problems of metadata management in the system of FIG. 6 is for computer system 105 to include cache 605. Cache 605 can store metadata about information cards of the user managed by various identity providers. This information can then be used to determine how to modify the presentation of information cards for the user. The issue then reduces to one of managing the update of cache 605.

In one embodiment of the invention, computer system 105 requests metadata from each identity provider when the system connects to the network (or at some regular intervals thereafter: for example, once per day). In another embodiment, each time computer system 105 requests a security token from identity provider 135, computer system 105 also requests a copy of the metadata in metadata store 240 (at least, the metadata applicable to information cards managed by identity provider 135 that belong to the user). Computer system 105 then uses this information, however requested and whenever received, to update cache 605. A person skilled in the art will recognize other ways in which computer system 105 can update cache 605. A person skilled in the art will also recognize that these update policies mean that cache 605 may be out-of-date when card selector 205 accesses the metadata from cache 605. These concerns exist, but it is better to use accurate (if slightly out-of-date) information in the presentation of information cards than to not have the metadata at all.

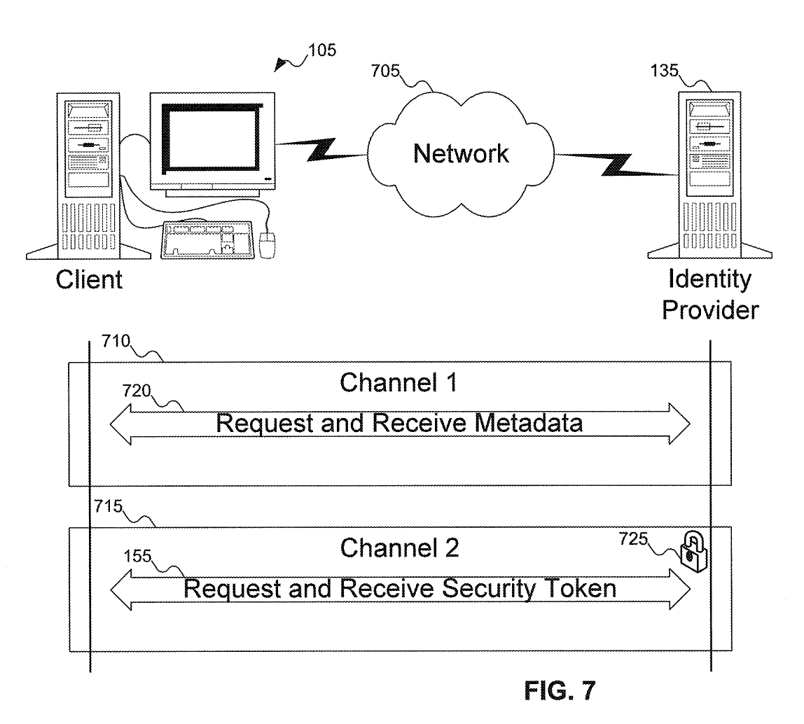

In situations where computer system 105 requests the metadata from identity provider 135 separately from the request for the security token, there can be multiple channels used for communications between computer system 105 and identity provider 135. FIG. 7 shows the client and identity provider in the system of FIG. 6 communicating via multiple channels. A person skilled in the art will recognize that a channel can refer to multiple requests at different times along similar (or identical) paths between computer system 105 and identity provider 135, or that different paths can be used. In one embodiment, computer system 105 and identity provider 135 are both connected to a network, such as network 705. For example, network 705 can be a global network, such as the Internet. Alternatively, computer system 105 and identity provider 135 might be connected by other types of networks, such as a cellular network. (This embodiment might be used when the user is using a cellular telephone to authorize a transaction, with the card selector implemented on a cellular telephone or personal digital assistant.) In yet other embodiments, there can be multiple different types of networks connecting computer system 105 and identity provider 135.

S A channel is a means of communication between computer system 105 and identity provider 135. A channel can include the physical constructs connecting computer system 105 and identity provider 135, the protocols used to manage the communication, and an identifier of a particular communication session between computer system 105 and identity provider 135, among other elements. For example, where both computer system 105 and identity provider 135 are connected to the Internet, the physical constructs between computer system 105 and identity provider 135 can include routers and cabling (or wireless routers, if some portion of the channel includes wireless communication). If a channel requires that communications travel between computer system 105 and identity provider 135 along a specific sequence of machines, this information form part of the definition of the channel. On the other hand, if the path between the machines is not critical, communications might travel along different paths, even while part of the same channel. Similarly, communications along different channels might include different protocols used to manage the message traffic. Finally, even if identical paths and protocols are used, communications between computer system 105 and identity provider 135 might involve different channels, if the communications are considered to be part of different sessions between the machines.

In FIG. 7 computer system 105 and identity provider 135 are shown communicating using two different channels. The specifics of what distinguish channel 710 from channel 715 can vary as discussed above, and are not important, beyond the fact that two different channels are being used. Channel 710 is shown as being used to manage the request for and receipt of the metadata from identity provider 135, as shown in communication 720. Channel 715 is shown as being used to manage the request for a receipt of the security token from identity provider, as shown in communication 155. Because the security token contains important information about the user, channel 715 is encrypted, as shown by encryption icon 725. Channel 710 is not shown as encrypted, because the information being transmitted is not considered to be sensitive (hence the lack of an encryption icon in channel 710). But if the metadata were considered sensitive, channel 710 could be encrypted as well.

While FIG. 7 shows computer system 105 requesting metadata from identity provider 135, a person skilled in the art will recognize other ways in which computer system 105 can receive metadata from identity provider 135. For example, rather than waiting for a request from computer system 105, identity provider 135 can push information to computer system 105 when computer system 105 is reachable. In a push model, the machine with the information waits until the destination machine is known to be reachable, and then sends the information to the destination machine, without waiting for the destination machine to request the information. Because secure tokens are not sent using a push model, the delivery of the metadata can be in a channel other than that used to request and deliver the secure token.

In FIGS. 6-7, the system is shown as including an identity provider that manages information cards. But a person skilled in the art will recognize that embodiments of the invention are also applicable to electronic wallets and keyrings that store information about the user remotely, among other possibilities. A person skilled in the art will recognize how the system of FIGS. 6-7 can be modified where the information is stored remotely on a machine that is not an identity provider.

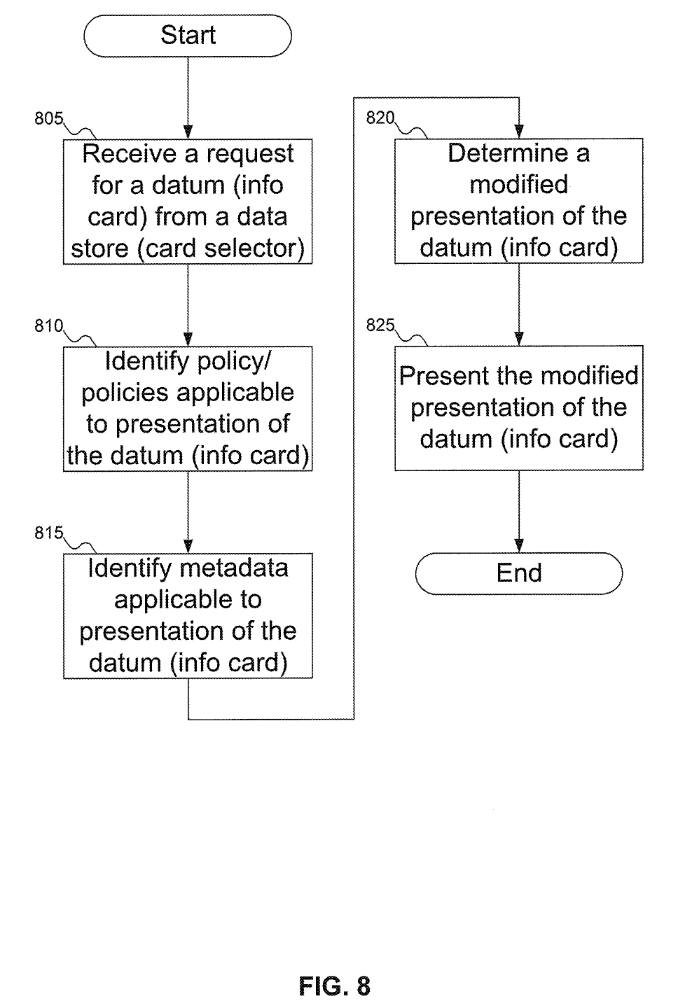

FIG. 8 shows a flowchart of a procedure to present the user with visual and/or non-visual cues regarding the state of information in system of FIG. 2 and 7. In FIG. 8, at block 805, a system receives a request for a datum from a data store. As discussed above, in one embodiment, this data store is a card selector, and the datum being requested is an information card. At block 810, the system determines policies that are applicable to the information card. At block 815, the system determines the metadata applicable to the information card. At block 820, given the combination of the policy and the metadata, the system determines a modified presentation of the information card. As discussed above, this modified presentation can affect visual, aural, and other presentations of the information card, thereby adding the appropriate cues to the information card. Finally, at block 825, the system presents the modified information card to the user, giving the user the appropriate cues regarding the information card.

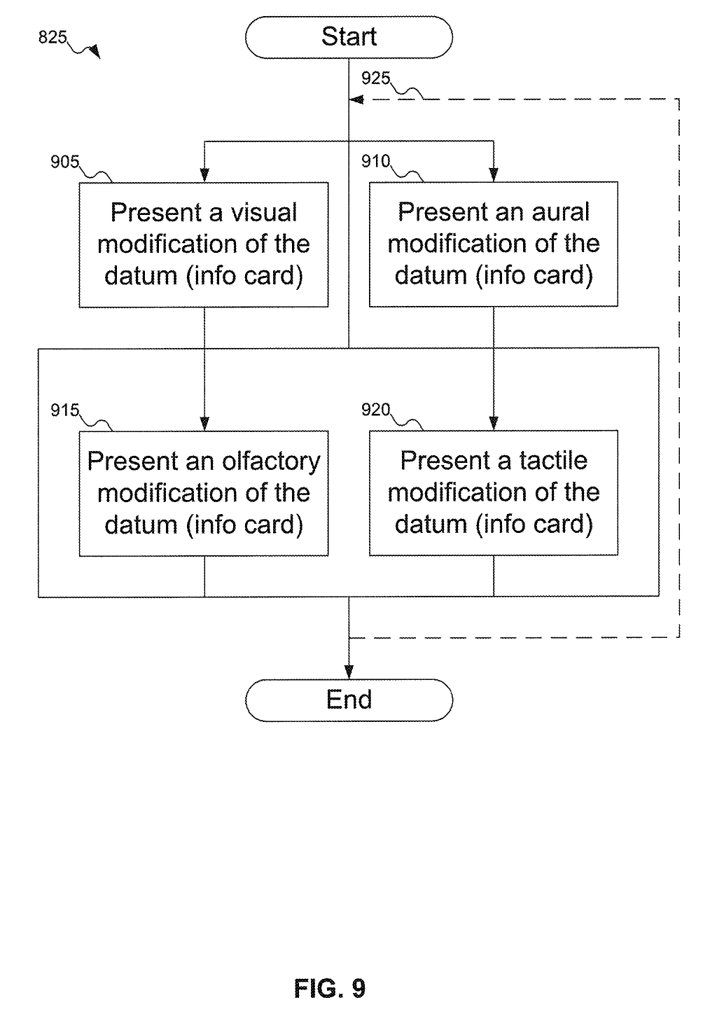

FIG. 9 shows details regarding the presentation of visual and/or non-visual cues regarding the state of information in the flowchart of FIG. 8. In FIG. 9, at block 905, the system can present visual cues regarding the information card. At block 910, the system can present aural cues regarding the information card. At block 915, the system can present olfactory cues regarding the information card. At block 920, the system can present tactile cues regarding the information card. And if cues of different types apply, the system can repeat the appropriate blocks, as shown by dashed arrow 925.

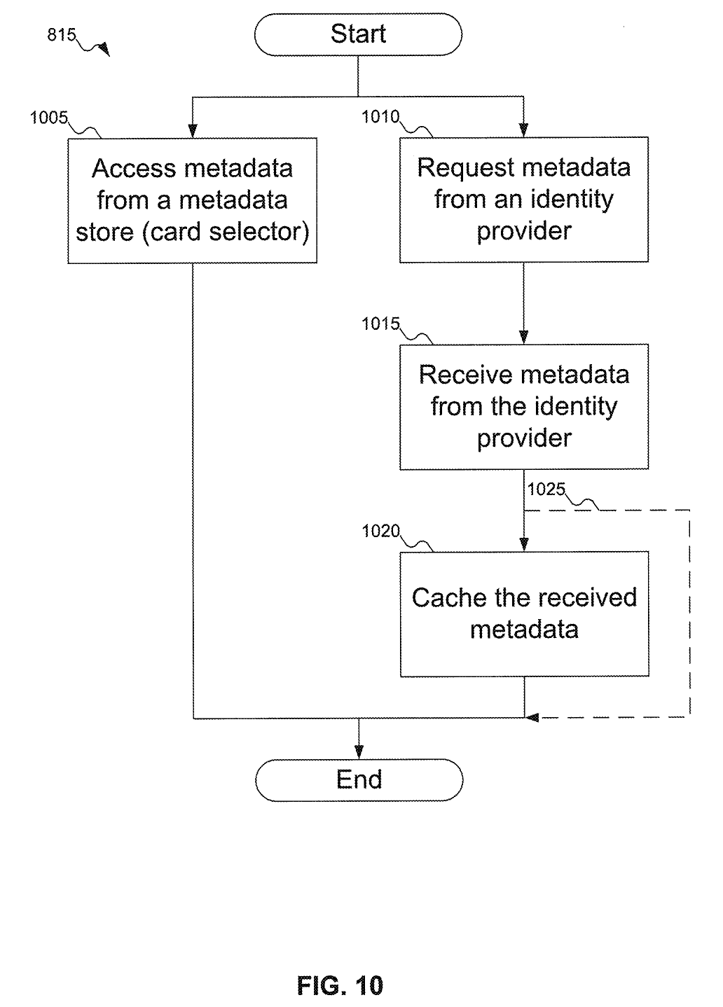

FIG. 10 shows details regarding the use of metadata in the presentation of visual and/or non-visual cues regarding the state of information in the flowchart of FIG. 8. In FIG. 10, at block 1005, the system accesses metadata from a metadata store that is local to the system. In the system of FIG. 2, this could be metadata store 240; in the system of FIG. 6, this could be cache 605. Alternatively, at block 1010, the system can request metadata from an identity provider. At block 1015, the system can receive the metadata, which can then be used as described in block 820 of FIG. 8. Finally, at block 1020, the system can cache the metadata for later use. Block 1020 is optional, as shown by dashed arrow 1025.

As discussed previously, while the above description is in the context of a client using metadata in a card selector, a person skilled in the art will recognize how embodiments of the invention could be used with other data stores, such as electronic wallets and keyrings. Further, embodiments of the invention can be used in contexts other than transactions with relying parties. More particularly, any time a card selector is invoked, the card selector can use metadata to affect the presentation of the information cards in the card selector. As it is possible for applications other than a web browser visiting a relying party's web site to activate the card selector, the card selector can present cues regarding information cards whenever invoked, by whatever application.

The following discussion is intended to provide a brief, general description of a suitable machine in which certain aspects of the invention may be implemented. Typically, the machine includes a system bus to which is attached processors, memory, e.g., random access memory (RAM), read-only memory (ROM), or other state preserving medium, storage devices, a video interface, and input/output interface ports. The machine may be controlled, at least in part, by input from conventional input devices, such as keyboards, mice, etc., as well as by directives received from another machine, interaction with a virtual reality (VR) environment, biometric feedback, or other input signal. As used herein, the term “machine” is intended to broadly encompass a single machine, or a system of communicatively coupled machines or devices operating together. Exemplary machines include computing devices such as personal computers, workstations, servers, portable computers, handheld devices, telephones, tablets, etc., as well as transportation devices, such as private or public transportation, e.g., automobiles, trains, cabs, etc.

The machine may include embedded controllers, such as programmable or non-programmable logic devices or arrays, Application Specific Integrated Circuits, embedded computers, smart cards, and the like. The machine may utilize one or more connections to one or more remote machines, such as through a network interface, modem, or other communicative coupling. Machines may be interconnected by way of a physical and/or logical network, such as an intranet, the Internet, local area networks, wide area networks, etc. One skilled in the art will appreciate that network communication may utilize various wired and/or wireless short range or long range carriers and protocols, including radio frequency (RF), satellite, microwave, Institute of Electrical and Electronics Engineers (IEEE) 545.11, Bluetooth, optical, infrared, cable, laser, etc.

The invention may be described by reference to or in conjunction with associated data including functions, procedures, data structures, application programs, instructions, etc. which, when accessed by a machine, result in the machine performing tasks or defining abstract data types or low-level hardware contexts. Associated data may be stored in, for example, the volatile and/or non-volatile memory, e.g., RAM, ROM, etc., or in other storage devices and their associated storage media, including hard-drives, floppy-disks, optical storage, tapes, flash memory, memory sticks, digital video disks, biological storage, and other tangible, physical storage media. Associated data may also be delivered over transmission environments, including the physical and/or logical network, in the form of packets, serial data, parallel data, propagated signals, etc., and may be used in a compressed or encrypted format. Associated data may be used in a distributed environment, and stored locally and/or remotely for machine access.

Having described and illustrated the principles of the invention with reference to illustrated embodiments, it will be recognized that the illustrated embodiments may be modified in arrangement and detail without departing from such principles, and may be combined in any desired manner. And although the foregoing discussion has focused on particular embodiments, other configurations are contemplated. In particular, even though expressions such as “according to an embodiment of the invention” or the like are used herein, these phrases are meant to generally reference embodiment possibilities, and are not intended to limit the invention to particular embodiment configurations. As used herein, these terms may reference the same or different embodiments that are combinable into other embodiments.

Consequently, in view of the wide variety of permutations to the embodiments described herein, this detailed description and accompanying material is intended to be illustrative only, and should not be taken as limiting the scope of the invention. What is claimed as the invention, therefore, is all such modifications as may come within the scope and spirit of the following claims and equivalents thereto.

1. An apparatus, comprising:
a data store (225) to store at least one datum (220);
a policy store (230) to store at least one policy (235) applicable to data in the data store (225);
a presentation modifier (205, 505) to produce a modified presentation (510) of said datum (220) based on said at least one policy (235); and
a presentation engine (205) to present said modified presentation (510) of said datum (220).

2. An apparatus according to claim 1, further comprising a receiver (210) to receive a request to present said datum (220).

3. An apparatus according to claim 1, wherein:
the data store (225) includes a card selector (205) to store an identifier of an information card (220);
the policy store (230) is operative to store at least one policy (235) applicable to said information card (220);
the presentation modifier (205, 505) is operative to produce a modified presentation (510) of said information card (220) based on said at least one policy (235); and
the presentation engine (205) is operative to present said modified presentation (510) of said information card (220).

4. An apparatus according to claim 3, wherein the presentation modifier (205, 505) is operative to modify a visual presentation of said information card (220).

5. An apparatus according to claim 3, wherein the presentation modifier (205, 505) is operative to modify an aural presentation of said information card (220).

6. An apparatus according to claim 3, wherein:
the policy store (230) is operative to store a plurality of policies (230) applicable to said information card (220);
the presentation modifier (205, 505) is operative to produce a composite modified presentation (510) of said information card (220) based on said plurality of policies (235); and
the presentation engine (205) is operative to present said composite modified presentation (510) of said information card (220).

7. An apparatus according to claim 3, further comprising a metadata store (240) to store said metadata (245).

8. An apparatus according to claim 7, further comprising:
a transmitter (215) to transmit a request for said metadata (245) from an identity provider (135); and
a receiver (210) to receive said metadata (245) from said identity provider (135).

9. An apparatus according to claim 8, wherein:
the transmitter (215) is operative to transmit a request (720) for said metadata (245) from said identity provider (135) via a first channel (710) and a request (155) for a security token (160) from said identity provider (135) via a second channel (715), said second channel (715) different from said first channel (710); and
the receiver (210) to receive said metadata (245) from said identity provider (135) via said first channel (710) and said security token (160) from said second channel (715).

10. An apparatus according to claim 9, further comprising a cache (605) to cache said metadata (245) received from said identity provider (135).

11. An apparatus according to claim 1, wherein the presentation engine (205) is operative to present said modified presentation (510) of said datum (220) by doing at least one of: fraying an edge, curling an edge, burning an edge, cracking said presentation, cutting said presentation, shredding said presentation, melting said presentation, wobbling said presentation, or making said presentation difficult to select by a user.

12. A method for presenting cues, comprising:
receiving (805) a request to access a datum (220) from a data store (225);
identifying (810) a policy (235) applicable to a presentation of the datum (220) from the data store (225);
identifying (815) metadata (245) applicable to the presentation of the datum (220);
determining (820) a modified presentation (510) of the datum (220) based on the policy (235) and the metadata (245); and
presenting (825) the modified presentation (510) of the datum (220).

13. A method according to claim 12, wherein:
receiving (805) a request to access a datum (220) from a data store (225) includes receiving (805) a request to access an information card (220) from a card store (225);
identifying (810) a policy (235) applicable to a presentation of the datum (220) from the data store (225) includes identifying (810) a policy (235) applicable to a presentation of the information card (220);
identifying (815) metadata (245) applicable to the presentation of the datum (220) includes identifying (815) metadata (245) applicable to the presentation of the information card (220);
determining (820) a modified presentation (510) of the datum (220) includes determining (820) a modified presentation (510) of the information card (220) based on the policy (235) and the metadata (245); and
presenting (825) the modified presentation (510) of the datum (220) includes presenting (825) the modified presentation (510) of the information card (220) in a card selector (225).

14. A method according to claim 13, wherein presenting (825) the modified presentation (510) of the information card (220) in a card selector (225) includes presenting (905) a visual modification (510) of the information card (220) in the card selector (225).

15. A method according to claim 13, wherein presenting (825) the modified presentation (510) of the information card (220) in a card selector (225) includes presenting (910) an aural modification (510) of the information card (220) in the card selector (225).

16. A method according to claim 13, wherein:
identifying (810) a policy (235) includes identifying (810) a plurality of policies (235) applicable to the presentation of the information card (220);
determining (820) a modified presentation (510) of the information card (220) based on the policy (235) and the metadata (245) determining (820) a composite modified presentation (510) of the information card (220) based on the plurality of policies (235) applicable to the presentation of the information card (220); and
presenting (825) the modified presentation (510) of the information card (220) in a card selector (225) includes presenting (825) the composite modified presentation (510) of the information card (220) in the card selector (225).

17. A method according to claim 13, wherein identifying (815) metadata (245) applicable to the presentation of the information card (220) includes accessing (1005) the metadata (245) from the card selector (225).

18. A method according to claim 13, wherein:
receiving (805) a request to access an information card (220) from a card store (225) includes receiving (805) a request to access an information card (220) from an identity provider (225); and
identifying (815) metadata (245) includes accessing (1010, 1015) the metadata (245) from the identity provider (135).

19. A method according to claim 18, wherein accessing (1010, 1015) the metadata (245) from the identity provider (135) includes accessing (1010, 1015) the metadata (245) from the identity provider (135) via a first channel (710); and
the method further comprises receiving (165) a security token (160) from the identity provider (135) via a second channel (715), the second channel (715) different from the first channel (710).

20. A method according to claim 18, the method further comprising caching (1020) the metadata (245) from the identity provider (135).

21. A method according to claim 12, wherein determining (820) a modified presentation (510) of the datum (220) includes modifying the presentation of the datum (220) by doing at least one of: fraying an edge, curling an edge, burning an edge, cracking the presentation, cutting the presentation, shredding the presentation, melting the presentation, wobbling the presentation, or making the presentation difficult to select by a user.

22. An article, comprising a storage medium, said storage medium having stored thereon instructions that, when executed by a machine, result in:
receiving (805) a request to access a datum (220) from a data store (225);
identifying (810) a policy (235) applicable to a presentation of the datum (220) from the data store (225);
identifying (815) metadata (245) applicable to the presentation of the datum (220);
determining (820) a modified presentation (510) of the datum (220) based on the policy (235) and the metadata (245); and
presenting (825) the modified presentation (510) of the datum (220).

23. An article according to claim 22, wherein:
receiving (805) a request to access a datum (220) from a data store (225) includes receiving (805) a request to access an information card (220) from a card store (225);
identifying (810) a policy (235) applicable to a presentation of the datum (220) from the data store (225) includes identifying (810) a policy (235) applicable to a presentation of the information card (220);
identifying (815) metadata (245) applicable to the presentation of the datum (220) includes identifying (815) metadata (245) applicable to the presentation of the information card (220);
determining (820) a modified presentation (510) of the datum (220) includes determining (820) a modified presentation (510) of the information card (220) based on the policy (235) and the metadata (245); and
presenting (825) the modified presentation (510) of the datum (220) includes presenting (825) the modified presentation (510) of the information card (220) in a card selector (225).

24. An article according to claim 23, wherein presenting (825) the modified presentation (510) of the information card (220) in a card selector (225) includes presenting (905) a visual modification (510) of the information card (220) in the card selector (225).

25. An article according to claim 23, wherein presenting (825) the modified presentation (510) of the information card (220) in a card selector (225) includes presenting (910) an aural modification (510) of the information card (220) in the card selector (225).

26. An article according to claim 23, wherein:
identifying (810) a policy (235) includes identifying (810) a plurality of policies (235) applicable to the presentation of the information card (220);
determining (820) a modified presentation (510) of the information card (220) based on the policy (235) and the metadata (245) determining (820) a composite modified presentation (510) of the information card (220) based on the plurality of policies (235) applicable to the presentation of the information card (220); and
presenting (825) the modified presentation (510) of the information card (220) in a card selector (225) includes presenting (825) the composite modified presentation (510) of the information card (220) in the card selector (225).

27. An article according to claim 23, wherein identifying (815) metadata (245) applicable to the presentation of the information card (220) includes accessing (1005) the metadata (245) from the card selector (225).

28. An article according to claim 23, wherein:
receiving (805) a request to access an information card (220) from a card store (225) includes receiving (805) a request to access an information card (220) from an identity provider (225); and
identifying (815) metadata (245) includes accessing (1010, 1015) the metadata (245) from the identity provider (135).

29. An article according to claim 28, wherein accessing (1010, 1015) the metadata (245) from the identity provider (135) includes accessing (1010, 1015) the metadata (245) from the identity provider (135) via a first channel (710); and
said storage medium has stored thereon further instructions that, when executed by the machine, result in receiving (165) a security token (160) from the identity provider (135) via a second channel (715), the second channel (715) different from the first channel (710).

30. An article according to claim 28, said storage medium has stored thereon further instructions that, when executed by the machine, result in caching (1020) the metadata (245) from the identity provider (135).

31. An article according to claim 22, wherein determining (820) a modified presentation (510) of the datum (220) includes modifying the presentation of the datum (220) by doing at least one of: fraying an edge, curling an edge, burning an edge, cracking the presentation, cutting the presentation, shredding the presentation, melting the presentation, wobbling the presentation, or making the presentation difficult to select by a user.
